(19) United States
(12) Patent Application Publication
(10) Pub. No.: US 2023/0019030 A1
(43) Pub. Date: Jan. 19, 2023

(54) THREE-WAY SLEEVE, SUPPORTING FRAME AND TENT

(71) Applicant: Sinowell (Shanghai) Co., Ltd., Shanghai (CN)

(72) Inventor: Jia Luo, Shanghai (CN)

(21) Appl. No.: 17/950,258

(22) Filed: Sep. 22, 2022

(30) Foreign Application Priority Data
May 7, 2022 (CN) 202221079342.3

(51) Int. Cl. E04H 15/44; F16B 7/04

(52) U.S. Cl. CPC E04H 15/44; F16B 7/048

(57) ABSTRACT

A three-way sleeve includes a first sleeve, a second sleeve and a third sleeve that intersect with each other, and every two of a length direction of the first sleeve, a length direction of the second sleeve and a length direction of the third sleeve are perpendicular to each other. The first sleeve, the second sleeve and the third sleeve are each provided with an assembling through hole. At least one of an inner wall and an outer wall of the first sleeve, the second sleeve and the third sleeve are each provided with a circumferentially arranged limit protrusion. The first sleeve, the second sleeve and the third sleeve are integrally formed.

### CROSS-REFERENCE TO RELATED APPLICATION(S)

This application claims priority to Chinese Patent Application No. 202221079342.3 filed May 7, 2022, the disclosure of which is incorporated herein by reference in its entirety.

### TECHNICAL FIELD

The present disclosure relates to the technical field of supporting frames, and more particularly, to a three-way sleeve, a supporting frame, and a tent.

### BACKGROUND

In order to create a suitable growing environment for plants, it is required to use a plant growing tent. Plants are planted in the plant growing tent, and simply by controlling parameters such as temperature and humidity, light intensity, gas composition and gas concentration in the tent, suitable growing environments can be created for different plants. However, the existing plant growing tent is prone to have issues such as being deformed at an intersection portion of pipes, which greatly reduces the service life of the plant growing tent.

Therefore, it is urgently needed to develop a three-way sleeve, a support frame and a tent to address the above issues.

### SUMMARY

An aspect of the disclosure is to provide a three-way sleeve, which is used at an intersection portion of pipes and can improve the strength of the intersection portion of the pipes, thereby preventing the deformation of the plant growing tent and prolonging a service life of the plant growing tent.

To achieve this aspect, the technical solutions described below are adopted in the present disclosure.

Provided is a three-way sleeve, where the three-way sleeve includes a first sleeve, a second sleeve and a third sleeve intersecting with each other. Every two of a length direction of the first sleeve, a length direction of the second sleeve and a length direction of the third sleeve are perpendicular to each other. The first sleeve, the second sleeve and the third sleeve are each provided with an assembling through hole. At least one of an inner wall and an outer wall of each of the first sleeve, the second sleeve and the third sleeve is provided with a circumferentially arranged limit protrusion. The first sleeve, the second sleeve and the third sleeve are integrally formed.

As a preferable embodiment of the three-way sleeve, At least one of the inner wall and the outer wall of the first sleeve, the second sleeve and the third sleeve are each provided with a circumferentially arranged guiding portion configured to guide a pipe when the pipe is plugged into the three-way sleeve.

As a preferable embodiment of the three-way sleeve, the three-way sleeve includes a three-way solid member and three sleeving pipes, the three-way solid member has three solid columns intersecting with each other, and every two of the three solid columns are arranged perpendicularly to each other, the three sleeving pipes are respectively sleeved on the three solid columns, to respectively form the first sleeve, the second sleeve and the third sleeve intersecting with each other.

Another aspect of the present disclosure is to provide a supporting frame, which can ensure the strength of the intersection portion of the pipes, prevent the deformation of the plant growing tent, and prolong its service life.

To achieve this aspect, the technical solutions described below are adopted in the present disclosure.

A supporting frame, includes multiple pipes and multiple three-way sleeves as described above.

As a preferable embodiment of the supporting frame, at least two pipes are sequentially connected by plugging to form a pipe assembly, two ends of each pipe assembly are plugged into two of the three-way sleeves, respectively. The first sleeve, the second sleeve and the third sleeve of each of the three-way sleeves each have one pipe assembly plugged in by one pipe assembly so that the supporting frame has an accommodating cavity inside.

As a preferable embodiment of the supporting frame, the supporting frame further includes multiple spring bolts. Two ends of the pipe are each provided with a mounting through hole, and the spring bolt passes through the assembling through hole and the mounting through hole.

As a preferable embodiment of the supporting frame, the spring bolt includes a positioning member and a spring, the spring is sleeved on the positioning member, and the positioning member includes a positioning column and an end protrusion connected to each other, one end of the spring is connected to an end of the positioning column away from the end protrusion, a largest circular surface of the end protrusion has a diameter A, the mounting through hole has a diameter B, a cross section of the spring has a diameter C, the assembling through hole has a diameter D, and the positioning column has a diameter E, where A>B>C>D>E.

As a preferable embodiment of the supporting frame, the supporting frame further includes a supporting rod, where two ends of the supporting rod are provided with two fixing tips respectively, and the two fixing tips are respectively lap jointed onto two of the pipe assemblies arranged oppositely.

As a preferable embodiment of the supporting frame, an inner wall of each of the first sleeve, the second sleeve and the third sleeve is provided with a positioning projection in the length direction of the respective sleeve, and an outer wall of the pipe is provided with a positioning groove; or an outer wall of each of the first sleeve, the second sleeve and the third sleeve is provided with a positioning projection in the length direction of the respective sleeve, and an inner wall of the pipe is provided with a positioning groove, the positioning projection is fitted with the positioning groove.

Still another aspect of the present disclosure is to provide a tent, which can be used as a plant growing tent, and the strength of the intersection portions of the pipes of the tent is high, which can prevent deformation of the tent and prolong the service life of the tent.

To achieve this aspect, the technical solutions described below are adopted in the present disclosure.

A tent, includes the supporting frame as described above.

The present disclosure has the following beneficial effects:

The present disclosure provides the three-way sleeve, which includes the first sleeve, the second sleeve and the third sleeve intersecting with each other, where every two of the length direction of the first sleeve, the length direction of the second sleeve and the length direction of the third sleeve are perpendicular to each other, the first sleeve, the second sleeve and the third sleeve are each provided with the assembling through hole, the limit protrusions are circumferentially provided on at least one of the inner wall and outer wall of the first sleeve, the second sleeve and the third sleeve. The first sleeve, the second sleeve and the third sleeve are integrally formed, which can just ensure the structural strength of the three-way sleeve, and the three-way sleeve is arranged at the intersection portion of the pipes, and multiple pipes are respectively plugged in the first sleeve, the second sleeve and the third sleeve, thus, the structural strength of the intersection portion of the pipes can be ensured, thereby preventing the deformation of the plant growing tent and prolonging its service life.

The disclosure further provides the supporting frame including multiple pipes and multiple three-way sleeves as described above, it can be known that the intersection portion of pipes of the supporting frame has a high structural strength.

The disclosure further provides the tent including the supporting frame described above, the tent is not prone to being deformed and has a long service life.

### BRIEF DESCRIPTION OF DRAWINGS

FIG. 1 is an exploded view of a three-way sleeve taken from a first view according to an embodiment of the present disclosure;

FIG. 2 is an exploded view of a three-way sleeve taken from a second view according to the embodiment of the present disclosure;

FIG. 3 is a schematic structural view of a supporting frame according to an embodiment of the present disclosure;

FIG. 4 is a partially cross-sectional view of a three-way sleeve, a pipe assembly, and a spring bolt according to embodiments of the present disclosure.

### REFERENCE LIST

1 three-way sleeve
11 first sleeve
12 second sleeve
13 third sleeve
101 assembling through hole
1001 three-way solid member
10011 nesting portion
10012 abutment portion
10013 solid column
1002 sleeving pipe
2 pipe assembly
21 pipe
211 mounting through hole
3 spring bolt
31 positioning member
311 positioning column
312 end protrusion
32 spring
4 supporting rod
41 fixing tip
5 accommodating cavity

### DETAILED DESCRIPTION

The technical solutions according to the present disclosure are further described hereinafter through embodiments and drawings. It is to be understood that the embodiments set forth below are intended to illustrate rather than limiting the present disclosure. In addition, it is to be noted that, for ease of description, only the parts, instead of all, related to the present disclosure are illustrated in the drawings.

In the description of the present disclosure, it is to be noted that, unless otherwise expressly specified and limited, the terms “mounting”, “connected to each other”, “connected” are to be construed in a broad sense, for example, as permanently connected or detachably connected; mechanically connected or electrically connected; directly connected to each other or indirectly connected to each other via an intermediary; or internally connection of two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact, or be in contact via another feature between the two features. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

The conventional plant growing tent is prone to having issues such as deformation at the intersection portion of its pipes, which significantly reduces service life of the plant growing tent. Accordingly, a three-way sleeve is provided according to this embodiment, which is used at an intersection portion of pipes to improve the strength of the intersection portion of the pipes, prevent deformation of the plant growing tent, and prolong the service life of the plant growing tent.

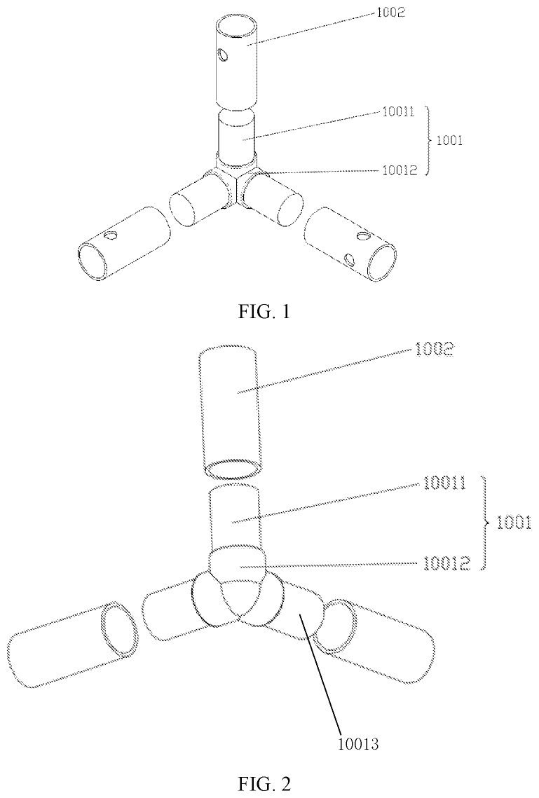

As shown in FIG. 1 to FIG. 3, the three-way sleeve 1 includes a first sleeve 11, a second sleeve 12 and a third sleeve 13 intersecting with each other, where every two of a length direction of the first sleeve 11, a length direction of the second sleeve 12 and a length direction of the third sleeve 13 are perpendicular to each other. The first sleeve 11, the second sleeve 12 and the third sleeve 13 are each provided with an assembling through hole 101. At least one of an inner wall and an outer wall of the first sleeve 11, the second sleeve 12 and the third sleeve 13 are each provided with a circumferentially arranged limit protrusion. The first sleeve 11, the second sleeve 12 and the third sleeve 13 are integrally formed, which can just ensure the structural strength of the three-way sleeve 1, and the three-way sleeve 1 is arranged at an intersection portion of pipes 21, and multiple pipes 21 are respectively plugged in the first sleeve 11, the second sleeve 12 and the third sleeve 13, thus, the structural strength of the intersection portion of the pipes 21 may just be ensured, thereby preventing the deformation of the plant growing tent and prolonging its service life.

In order to facilitate the plugging of the multiple pipes 21 into the three-way sleeve 1, preferably, at least one of the inner wall and the outer wall of the first sleeve 11, the second sleeve 12 and the third sleeve 13 are each provided with a circumferentially arranged guiding portion configured to guide a pipe 21 when the pipe 21 is plugged into the three-way sleeve 1. In this embodiment, the first sleeve 11, the second sleeve 12 and the third sleeve 13 have the same diameter to facilitate fitting of the same type of pipes 21. It can be known that in a case where the pipes 21 have a diameter larger than the diameters of the first sleeve 11, the second sleeve 12 and the third sleeve 13, the pipes 21 are sleeved on the first sleeve 11, the second sleeve 12 and the third sleeve 13, and thus the guiding portions on the outer wall of the first sleeve 11, the second sleeve 12 and the third sleeve 13 can be used to guide the sleeving. In contrast, in a case where the pipes 21 have a diameter smaller than the diameters of the first sleeve 11, the second sleeve 12, and the third sleeve 13, the pipes 21 are plugged into the first sleeve 11, the second sleeve 12, and the third sleeve 13, and thus the guiding portions on the inner wall of the first sleeve 11, the second sleeve 12, and the third sleeve 13 can be used to guide the plugging.

Taking the diameters of the pipes 21 smaller than the diameters of the first sleeve 11, the second sleeve 12 and the third sleeve 13 as an example, preferably, the limit protrusions and the guiding portions are all provided on the inner walls of the first sleeve 11, the second sleeve 12 and the third sleeve 13, and the limit protrusions are closer to the intersection portion than the guiding portion to the intersection portion, and a maximum radial thickness of the guiding portion is smaller than a maximum radial thickness of the limit protrusion, to ensure that an end of the pipe 21 can abut against a lateral side of the limit protrusion after being guided by the guiding portion.

In order to further ensure the structural strength of the three-way sleeve 1, as shown in FIG. 1 and FIG. 2, in this embodiment, the three-way sleeve 1 includes a three-way solid member 1001 and three sleeving pipes 1002, the three-way solid member 1001 has three solid columns 10013 intersecting with each other, and every two of the three solid columns 10013 are arranged perpendicularly to each other, the three sleeving pipes 1002 are respectively sleeved on the three solid columns 10013, to respectively form the first sleeve 11, the second sleeve 12 and the third sleeve 13 intersecting with each other.

To facilitate the positioning of the sleeving pipe 1002 with respect to the solid column 10013, each solid column 10013 includes an abutment portion 10012 and a nesting portion 10011, and the abutment portions 10012 of the three solid columns 10013 meet to form a three-way base body to further ensure the strength of the three-way solid member 1001.

Optionally, the abutment portion 10012 and the nesting portion 10011 each are injection molded.

Optionally, the abutment portion 10012 and the nesting portion 10011 are integrally injection molded.

Preferably, the nesting portion 10011 has a diameter smaller than an outer wall diameter of the abutment portion 10012, and the sleeving pipe 1002 has an inner wall diameter slightly larger than the diameter of the nesting portion 10011, to facilitate the assembling, and an outer wall diameter of the sleeving pipe 1002 is equal to the outer wall diameter of the abutment portion 10012 so as to ensure neatness in appearance. It can be known that the end surface of the nesting portion 10011 can also serve as a limit surface to limit the depth of plugging of the pipe 21 into the sleeving pipe 1002.

This embodiment further provides a supporting frame, which includes multiple pipes 21 and multiple three-way sleeves 1 as described above.

In order to reduce the length of each pipe 21 for ease of transport, preferably, at least two pipes 21 are sequentially connected by plugging to form a pipe assembly 2, two ends of each pipe assembly 2 are plugged into two of the three-way sleeves 1, respectively. The first sleeve 11, the second sleeve 12 and the third sleeve 13 of each of the three-way sleeves 1 each are plugged in by one pipe assembly 2 so that the supporting frame has an accommodating cavity 5 inside.

In order to facilitate the plugging connection of the pipe assembly 2 and the three-way sleeve 1 and the detachment of the pipe assembly 2 from the three-way sleeve 1, preferably, the supporting frame further includes multiple spring bolts 3, where two ends of the pipe 21 are each provided with a mounting through hole 211, and the spring bolt 3 passes through the assembling through hole 101 and the mounting through hole 211.

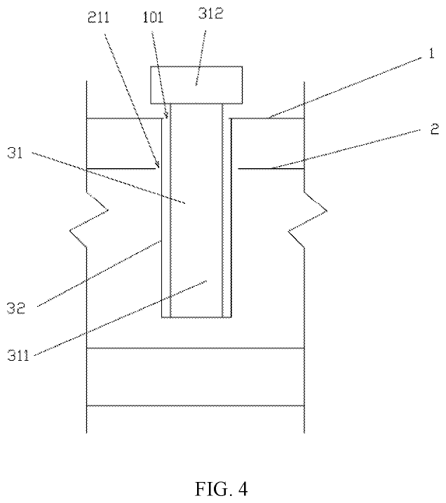

As shown in FIG. 4, preferably, the spring bolt 3 includes a positioning member 31 and a spring 32. The spring 32 is sleeved on the positioning member 31, and the positioning member 31 includes a positioning column 311 and an end protrusion 312 connected to each other. One end of the spring 32 is connected to an end of the positioning column 311 away from the end protrusion 312. A largest circular surface of the end protrusion 312 has a diameter A, the mounting through hole 211 has a diameter B, a cross section of the spring 32 has a diameter C, the assembling through hole 101 has a diameter D, and the positioning column 311 has a diameter E, where A>B>C>D>E, so that when the spring bolt 3 is plugged into the assembling through hole 101 and the mounting through hole 211, one end of the spring 32 abuts against the inner wall of the first sleeve 11, the second sleeve 12, or the third sleeve 13, and another end of the spring 32 is connected to the end of the positioning column 311.

Before the pipe assembly 2 and the three-way sleeve 1 are plugging-connected to each other, the end protrusion 312 is pulled to allow the spring 32 to be further compressed, then the pipe assembly 2 is plugged into the three-way sleeve 1, and the end protrusion 312 is released to allow the positioning column 311 to extend into the pipe cavity of the pipe assembly 2 under the restoring force of the spring 32 to achieve the positioning of the pipe assembly 2 and the three-way sleeve 1in the axial direction and circumferential direction with respect to each other.

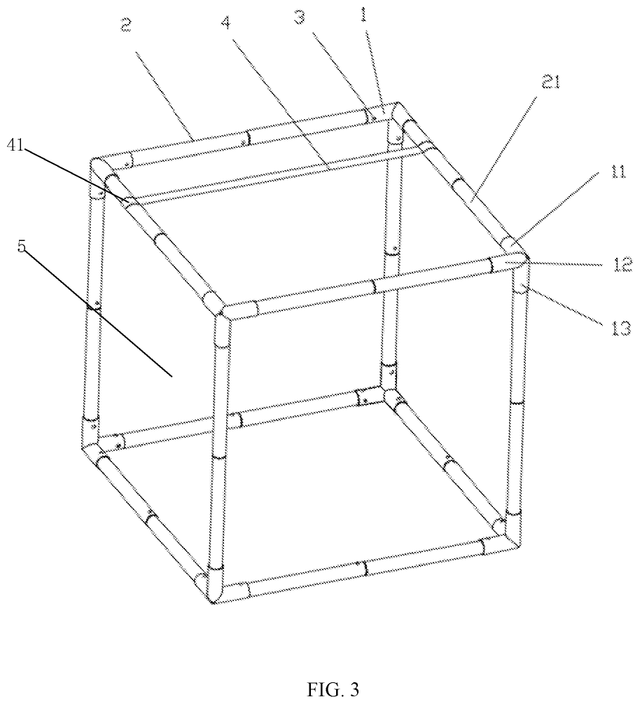

In order to further reinforce a part receiving a relatively large force of the pipe assembly 2, as shown in FIG. 3, preferably, he supporting frame further includes a supporting rod 4, two ends of the supporting rod 4 are each provided with a fixing tip 41, and the two fixing tips 41 are respectively lap-jointed onto two of the pipe assemblies 2 arranged oppositely. It can be known, the supporting rod 4 can strengthen the structural strength of the pipe assembly 2 in parallel with the supporting rod 4, so as to prevent the pipe assembly 2 from being deformed by force. Apparently, one supporting rod 4 can be provided according to the practical situation, or multiple supporting rods 4 can be provided at the same position or different positions.

In order to facilitate the circumferential positioning between the pipe assembly 2 and the three-way sleeve 1, in a case where the pipe 21 has a diameter smaller than the diameters of the first sleeve 11, the second sleeve 12 and the third sleeve 13, preferably, an inner wall of each of the first sleeve 11, the second sleeve 12 and the third sleeve 13 is provided with a positioning projection in the length direction of the respective sleeve, that is, the positioning projection extends in the length direction of the respective sleeve, and an outer wall of the pipe 21 is provided with a positioning groove, the positioning projection is fitted with the positioning groove, to facilitate the circumferential positioning between the pipe assembly 2 and the three-way sleeve 1, and facilitate the correspondence between the assembling through hole 101 and the mounting through hole 211. For the same principle, in a case where the pipe 21 has a diameter larger than the diameters of the first sleeve 11, the second sleeve 12 and the third sleeve 13, an outer wall of each of the first sleeve 11, the second sleeve 12 and the third sleeve 13 is provided with a positioning projection in the length direction of the respective sleeve, and an inner wall of the pipe 21 is provided with a positioning groove, the positioning projection is fitted with the positioning groove.

A tent including the supporting frame described above is further provided according to the embodiment. It can be known that the tent is not prone to being deformed, has a strong load-bearing capacity, and has a long service life.

What is claimed is:

1. A three-way sleeve, comprising a first sleeve, a second sleeve and a third sleeve intersecting with each other, wherein every two of a length direction of the first sleeve, a length direction of the second sleeve and a length direction of the third sleeve are perpendicular to each other, the first sleeve, the second sleeve and the third sleeve are each provided with an assembling through hole, at least one of an inner wall and an outer wall of each of the first sleeve, the second sleeve and the third sleeve is provided with a circumferentially arranged limit protrusion, and the first sleeve, the second sleeve and the third sleeve are integrally formed.

2. The three-way sleeve according to claim 1, wherein the three-way sleeve comprises a three-way solid member and three sleeving pipes, the three-way solid member has three solid columns intersecting with each other, and every two of the three solid columns are arranged perpendicularly to each other, the three sleeving pipes are respectively sleeved on the three solid columns, to respectively form the first sleeve, the second sleeve and the third sleeve intersecting with each other.

3. A supporting frame, comprising a plurality of pipes and a plurality of three-way sleeves according to claim 1.

4. The supporting frame according to claim 3, wherein the three-way sleeve comprises a three-way solid member and three sleeving pipes, the three-way solid member has three solid columns intersecting with each other, and every two of the three solid columns are arranged perpendicularly to each other, the three sleeving pipes are respectively sleeved on the three solid columns, to respectively form the first sleeve, the second sleeve and the third sleeve intersecting with each other.

5. The supporting frame according to claim 3, wherein at least two pipes are sequentially connected by plugging to form one of pipe assemblies, two ends of each of the pipe assemblies are plugged into two of the plurality of three-way sleeves respectively, the first sleeve, the second sleeve and the third sleeve of each of the three-way sleeves each are plugged in by one pipe assembly so that the supporting frame has an accommodating cavity inside.

6. The supporting frame according to claim 3, further comprising a plurality of spring bolts, wherein two ends of a pipe are each provided with a mounting through hole, and the spring bolt passes through the assembling through hole and the mounting through hole.

7. The supporting frame according to claim 6, wherein the spring bolt comprises a positioning member and a spring, the spring is sleeved on the positioning member, and the positioning member comprises a positioning column and an end protrusion connected to each other, one end of the spring is connected to an end of the positioning column away from the end protrusion, a largest circular surface of the end protrusion has a diameter A, the mounting through hole has a diameter B, a cross section of the spring has a diameter C, the assembling through hole has a diameter D, and the positioning column has a diameter E, wherein A>B>C>D>E.

8. The supporting frame according to claim 5, further comprising a supporting rod, wherein two ends of the supporting rod are provided with two fixing tip respectively, and the two fixing tips are respectively lap jointed onto two of the plurality of pipe assemblies arranged oppositely.

9. The supporting frame according to claim 3, wherein an inner wall of each of the first sleeve, the second sleeve and the third sleeve is provided with a positioning projection in a length direction of a respective sleeve, and an outer wall of each of the plurality of pipes is provided with a positioning groove, and the positioning projection is fitted with the positioning groove.

10. The supporting frame according to claim 3, wherein an outer wall of each of the first sleeve, the second sleeve and the third sleeve is provided with a positioning projection in a length direction of a respective sleeve, and an inner wall of the pipe is provided with a positioning groove, the positioning projection is fitted with the positioning groove.

11. A tent, comprising the supporting frame according to claim 3.
